(19) United States
(12) Patent Application Publication
(10) Pub. No.: US 2005/0018889 A1
(43) Pub. Date: Jan. 27, 2005

(54) Systems and methods for filtering images

(76) Inventor: Jianying Li, New Berlin, WI (US)

Correspondence Address: Patrick W. Rasche;Armstrong Teasdale LLP, Suite 2600, One Metropolitan Square, St. Louis, MO, 63102, US

(21) Appl. No.: 10/616,162

(22) Filed: Jul. 9, 2003

(51) Int. Cl. G06K 9/00

(52) U.S. Cl. 382/128; 378/901

(57) ABSTRACT

A method for filtering images is described. The method includes obtaining an image, and obtaining a final pixel value by performing a filtering operation on an initial pixel value of at least one pixel of the image and by modulating the filtering operation with a gain factor that is a function of the initial pixel value.

### BACKGROUND OF THE INVENTION

This invention relates generally to imaging systems and more particularly, to systems and methods for filtering images.

For computed tomography (CT) applications, a high contrast-to-noise ratio is desirable to detect low contrast lesions and high density organs, such as bones and stents in hearts of patients. However, boosting the contrast increases the noise of a CT image.

### BRIEF DESCRIPTION OF THE INVENTION

In one aspect, a method for filtering images is provided. The method includes obtaining an image, and obtaining a final pixel value by performing a filtering operation on an initial pixel value of at least one pixel of the image and by modulating the filtering operation with a gain factor that is a function of the initial pixel value.

In another aspect, a method for filtering images is provided. The method includes obtaining a computed tomography (CT) image, and obtaining a final pixel value by performing a filtering operation on an initial pixel value of at least one pixel of the CT image and by modulating the filtering operation with a gain factor that is a function of the initial pixel value.

In yet another aspect, a computer-readable medium encoded with a program is provided. The program is configured to obtain an image, and obtain a final pixel value by performing a filtering operation on an initial pixel value of at least one pixel of the image and by modulating the filtering operation with a gain factor that is a function of the initial pixel value.

In yet another aspect, a computer is provided. The computer is configured to obtain an image, and obtain a final pixel value by performing a filtering operation on an initial pixel value of at least one pixel of the image and by modulating the filtering operation with a gain factor that is a function of the initial pixel value.

In another aspect, a computed tomographic (CT) imaging system for filtering CT images is provided. The imaging system includes a detector array having a plurality of detectors, an x-ray source positioned to emit x-rays toward the detector array, and a processor operationally coupled to the detector array. The processor is configured to obtain an image, and obtain a final pixel value by performing a filtering operation on an initial pixel value of at least one pixel of the image and by modulating the filtering operation with a gain factor that is a function of the initial pixel value.

### BRIEF DESCRIPTION OF THE DRAWINGS

FIG. 1 is a embodiment of a CT imaging system in which systems and methods for filtering images is implemented.

FIG. 2 is a block schematic diagram of the CT imaging system of FIG. 1.

FIG. 3 is a flowchart of an embodiment of a method for filtering images.

FIG. 4 is a plot of gain factor versus relative pixel values to obtain the gain factor from the relative pixel values.

FIG. 5 shows CT images that are generated with and without using the method of FIG. 3.

FIG. 6 shows CT images that are generated with and without using the method of FIG. 3.

### DETAILED DESCRIPTION OF THE INVENTION

In some known CT imaging system configurations, an x-ray source projects a fan-shaped beam which is collimated to lie within an X-Y plane of a Cartesian coordinate system and generally referred to as an “imaging plane”. The x-ray beam passes through an object being imaged, such as a patient. The beam, after being attenuated by the object, impinges upon an array of radiation detectors. The intensity of the attenuated radiation beam received at the detector array is dependent upon the attenuation of an x-ray beam by the object. Each detector element of the array produces a separate electrical signal that is a measurement of the beam attenuation at the detector location. The attenuation measurements from all the detectors are acquired separately to produce a transmission profile.

In third generation CT systems, the x-ray source and the detector array are rotated with a gantry within the imaging plane and around the object to be imaged such that the angle at which the x-ray beam intersects the object constantly changes. A group of x-ray attenuation measurements, i.e., projection data, from the detector array at one gantry angle is referred to as a “view”. A “scan” of the object comprises a set of views made at different gantry angles, or view angles, during one revolution of the x-ray source and detector.

In an axial scan, the projection data is processed to construct an image that corresponds to a two dimensional slice taken through the object. One method for reconstructing an image from a set of projection data is referred to in the art as the filtered back projection technique. This process converts the attenuation measurements from a scan into integers called “CT numbers” or “Hounsfield units”, which are used to control the brightness of a corresponding pixel on a cathode ray tube display.

To reduce the total scan time, a “helical” scan may be performed. To perform a “helical” scan, the object is moved while the data for the prescribed number of slices is acquired. Such a system generates a single helix from a one fan beam helical scan. The helix mapped out by the fan beam yields projection data from which images in each prescribed slice may be reconstructed.

Reconstruction algorithms for helical scanning typically use helical weighing algorithms that weight the collected data as a function of view angle and detector channel index. Specifically, prior to a filtered backprojection process, the data is weighted according to a helical weighing factor, which is a function of both the gantry angle and detector angle. The helical weighting algorithms also scale the data according to a scaling factor, which is a function of the distance between the x-ray source and the object. The weighted and scaled data is then processed to generate CT numbers and to construct an image that corresponds to a two dimensional slice taken through the object.

As used herein, an element or step recited in the singular and preceded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Also as used herein, the phrase “reconstructing an image” is not intended to exclude embodiments of the present invention in which data representing an image is generated but a viewable image is not. However, many embodiments generate (or are configured to generate) at least one viewable image.

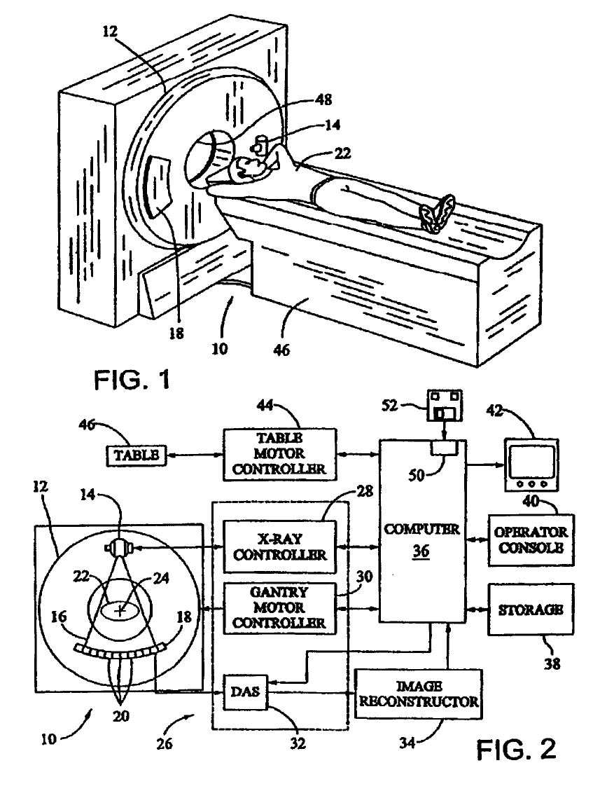

Referring to FIGS. 1 and 2, a multi-slice scanning imaging system, for example, a computed tomography (CT) imaging system 10, is shown as including a gantry 12 representative of a “third generation” CT imaging system. Gantry 12 has an x-ray source 14 that projects a beam of x-rays 16 toward a detector array 18 on the opposite side of gantry 12. Detector array 18 is formed by a plurality of detector rows (not shown) including a plurality of detector elements 20 which together sense the projected x-rays that pass through an object, such as a medical patient 22. Each detector element 20 produces an electrical signal that represents the intensity of an impinging x-ray beam and hence the attenuation of the beam as it passes through object or patient 22. During a scan to acquire x-ray projection data, gantry 12 and the components mounted thereon rotate about a center of rotation 24. FIG. 2 shows only a single row of detector elements 20 (i.e., a detector row). However, multislice detector array 18 includes a plurality of parallel detector rows of detector elements 20 such that projection data corresponding to a plurality of quasi-parallel or parallel slices can be acquired simultaneously during a scan.

Rotation of gantry 12 and the operation of x-ray source 14 are governed by a control mechanism 26 of CT system 10. Control mechanism 26 includes an x-ray controller 28 that provides power and timing signals to x-ray source 14 and a gantry motor controller 30 that controls the rotational speed and position of gantry 12. A data acquisition system (DAS) 32 in control mechanism 26 samples analog data from detector elements 20 and converts the data to digital signals for subsequent processing. An image reconstructor 34 receives sampled and digitized x-ray data from DAS 32 and performs high-speed image reconstruction. The reconstructed image is applied as an input to a computer 36 which stores the image in a mass storage device 38.

Computer 36 also receives commands and scanning parameters from an operator via console 40 that has a keyboard. An associated cathode ray tube display 42 allows the operator to observe the reconstructed image and other data from computer 36. The operator supplied commands and parameters are used by computer 36 to provide control signals and information to DAS 32, x-ray controller 28 and gantry motor controller 30. In addition, computer 36 operates a table motor controller 44 which controls a motorized table 46 to position patient 22 in gantry 12. Particularly, table 46 moves portions of patient 22 through gantry opening 48.

In one embodiment, computer 36 includes a device 50, for example, a floppy disk drive, CD-ROM drive, DVD drive, magnetic optical disk (MOD) device, or any other digital device including a network connecting device such as an Ethernet device for reading instructions and/or data from a computer-readable medium 52, such as a floppy disk, a CD-ROM, a DVD or an other digital source such as a network or the Internet, as well as yet to be developed digital means. In another embodiment, computer 36 executes instructions stored in firmware (not shown). Computer 36 is programmed to perform functions described herein, and as used herein, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein.

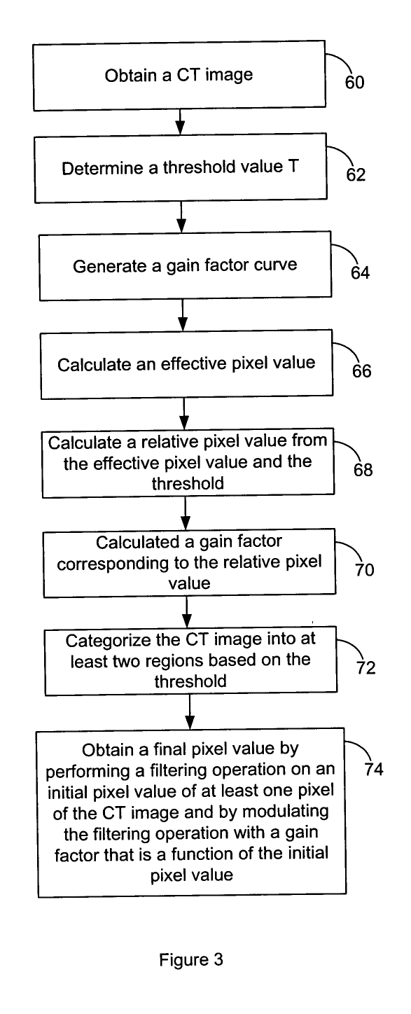

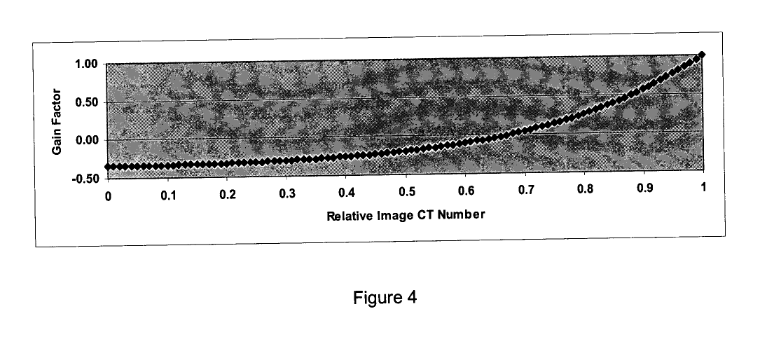

FIG. 3 is a flowchart of an embodiment of a method for filtering a CT image. The method is executed by computer 36 after it receives data representative of a CT image from image reconstructor 34. The method includes obtaining 60 a CT image and determining 62 a threshold value T. The method further includes generating 64 a gain factor curve, which is shown in FIG. 4, as a function of a relative pixel value Pᵣ(i, j) of a pixel (i, j) of the CT image. A gain factor has positive and negative values, such as, for instance, ranging from −0.5 to 1. The gain factor curve varies with CT applications. For example, stent enhancement in a cardiac application generates a different gain factor curve than a gain factor curve generated in an inner acoustic channel application. The method further includes calculating 66 an effective pixel value Pₑ(i,j) from a pixel value P(i, j) of the pixel (i, j) by using
Pₑ(i, j)=(P(i, j)+P(i−1, j)+P(i+1, j)+P(i, j−1)+P(i, j+1))/5 Equation(1)
where P(i−1, j), P(i+1, j), P(i, j−1), and P(i, j+1) are pixel values of pixels that are within 1 unit of the pixel (i, j). In an alternative embodiment, Pₑ(i,j) is obtained from pixel values of pixels that are within n units of the pixel (i, j), where n is a positive integer. Step 66 reduces the impact of noise for the pixel (i, j) of the CT image by the averaging operation. Step 66 is performed for every pixel of the CT image so that noise in each of the pixels of the CT image is reduced.

The method further includes calculating 68 a relative pixel value Pᵣ(i,j) from the effective pixel value by using
Pᵣ(i,j)=Pₑ(i, j)/T Equation(2)
Pᵣ(i,j) is limited to being equal to or less than 1. The method further includes calculating 70 the gain factor for the pixel (i, j) by using the gain factor curve of FIG. 4. In an embodiment, the gain factor is obtained as
Gain (i, j)=−0.35+0.1*Pᵣ(i, j)²+0.15*Pᵣ(i, j)²+0.2*Pᵣ(i, j)³+0.4*Pᵣ(i, j)⁴+0.5*Pᵣ(i, j)⁵ Equation(3)
where * is a multiplication operation.

The method further includes categorizing 72 the CT image into at least two regions of low, medium, and high density. The CT image is categorized based on a pixel where a gain factor, as shown in the gain factor curve, is zero. The number of regions depends on the CT application. The method further includes obtaining 74 a final pixel value P_{f}(i, j) of the pixel (i, j) by using
P_{f}(i, j)=P(i, j)−(P(i, j)−decon(P(i, j)))*Gain(i, j) Equation(4)
where decon(P(i,j)) is a deconvolution or a filtering operation performed on the initial pixel value P(i,j). The gain factor modulates the filtering operation. For pixels of the CT image whose values are less than a product of a constant and the threshold value T, the deconvolution operation is a smoothing operation, and for pixels of the CT image whose values are greater than the product, the deconvolution operation is a sharpening operation. The constant is determined from the gain factor curve. The smoothing operation is limited to pixels that belong to a particular region of the at least two regions to maintain a low contrast resolution and to avoid oversmoothing over different structures in the CT image. The region in which the smoothing operation is applied depends on the CT applications. The threshold value T may be adjusted later on the fly by the user based on the CT applications to change smoothness and sharpness of the CT image.

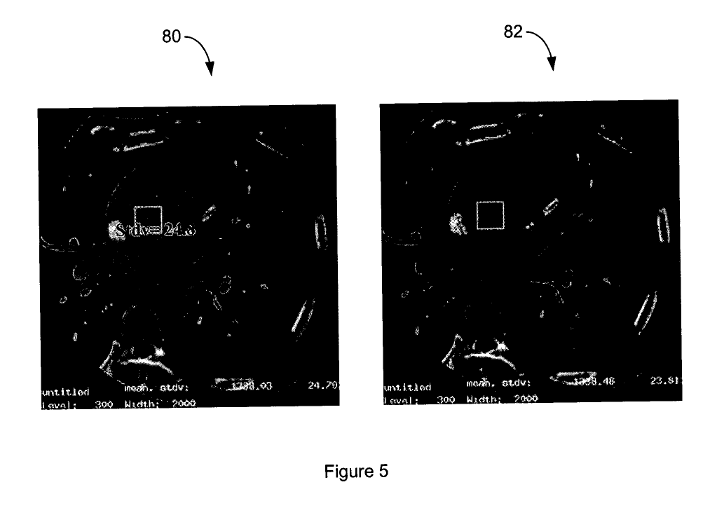

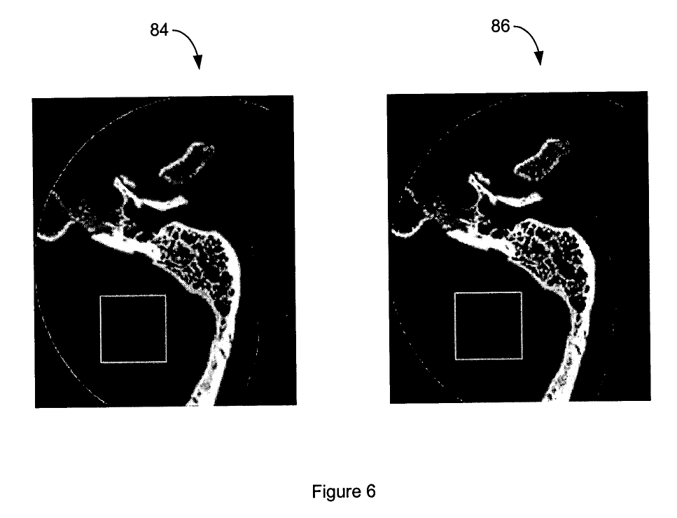

FIG. 5 shows CT images 80 and 82 of stents of patient 22. Image 80 is generated without using the method of FIG. 3 and image 82 is generated by using the method of FIG. 3. FIG. 6 shows CT images 84 and 86 of an inner acoustic canal of patient 22. Image 84 is generated without using the method of FIG. 3 and image 86 is generated by using the method of FIG. 3. Images 82 and 86 have better contrast than images 80 and 84.

Hence, the herein described systems and methods provide a generalized non-linear post-processing image filter for CT applications. The filter enhances the contrast for high-density objects, such as, bony structures and stents, in CT images while reducing image noise for soft tissues. This enables the user of CT system 10 to maintain or lower scan techniques and simultaneously obtain higher spatial resolution for the high-density objects. By reducing the noise in the soft tissues, the user increases the contrast-to-noise ratio, which improves detectability of low contrast regions.

While the invention has been described in terms of various specific embodiments, those skilled in the art will recognize that the invention can be practiced with modification within the spirit and scope of the claims.

1. A method for filtering images comprising:
obtaining an image; and
obtaining a final pixel value by performing a filtering operation on an initial pixel value of at least one pixel of the image and by modulating the filtering operation with a gain factor that is a function of the initial pixel value.

2. A method in accordance with claim 1 wherein obtaining the final pixel value comprises obtaining the final pixel value by using
P_{f}(i,j)=P(i,j)−(P(i, j)−decon(P(i,j)))*Gain(i,j), wherein P(i,j) is the initial pixel value, decon(P(i, j)) is a deconvolution operation performed on the initial pixel value, Gain(i, j) is the gain factor of the pixel, and (i, j) is the pixel.

3. A method in accordance with claim 1 further comprising categorizing the image into at least two regions of low, medium, and high density.

4. A method in accordance with claim 3 wherein modulating the filtering operation comprises:
performing a smoothing operation on one of the regions; and
limiting the smoothing operation to the region.

5. A method in accordance with claim 4 further comprising:
determining a threshold value T.

6. A method in accordance with claim 5 further comprising:
generating a gain factor curve as a function of a relative pixel value of each pixel of the image.

7. A method in accordance with claim 6 further comprising:
calculating an effective pixel value from the initial pixel value by using (Pₑ(i,j)=(P(i,j)+P(i−1,j)+P(i+1j)+P(i,j−1)+P(i,j+1))/⁵, wherein Pe (i,j) is the effective pixel value, and P(i−1, j), P(i+1, j), P(i, j−1), and P(i, j+1) are pixel values of pixels that are adjoining the pixel with pixel value P(i, j).

8. A method in accordance with claim 7 further comprising calculating the relative pixel value Pᵣ(i,j) from the effective pixel value by using Pᵣ(i,j)=Pₑ(i,j)/T.

9. A method in accordance with claim 8 further comprising calculating the gain factor of the pixel by using
Gain (i, j)=−0.35+0.1*Pᵣ(i, j)+0.15*Pᵣ(i, j)²+0.2*Pᵣ(i, j)³+0.4*Pᵣ(i, j)⁴+0.5
wherein Gain(i,j) is the gain factor, and wherein Gain(i,j) has positive and negative values.

10. A method for filtering images comprising:
obtaining a computed tomography (CT) image; and
obtaining a final pixel value by performing a filtering operation on an initial pixel value of at least one pixel of the CT image and by modulating the filtering operation with a gain factor that is a function of the initial pixel value.

11. A computer-readable medium encoded with a program configured to:
obtain an image; and
obtain a final pixel value by performing a filtering operation on an initial pixel value of at least one pixel of the image and by modulating the filtering operation with a gain factor that is a function of the initial pixel value.

12. A computer-readable medium in accordance with claim 11 wherein to obtain the final pixel value the program configured to obtain the final pixel value by using P_{f}(i, j)=P(i,j)−(P(i, j)−decon(P(i, j)))*Gain(i, j), wherein P(i, j) is the initial pixel value, decon(P(i, j)) is a deconvolution operation performed on the initial pixel value, Gain(i,j) is the gain factor of the pixel, and (i,j) is the pixel.

13. A computer-readable medium in accordance with claim 11 wherein the program is further configured to categorize the image into at least two regions of low, medium, and high density.

14. A computer-readable medium in accordance with claim 13 wherein to modulate the filtering operation the program configured to:
perform a smoothing operation on one of the regions; and
limit the smoothing operation to the region.

15. A computer-readable medium in accordance with claim 14 wherein the program is further configured to determine a threshold value T.

16. A computer-readable medium in accordance with claim 15 wherein the program is further configured to generate a gain factor curve as a function of a relative pixel value of each pixel of the image.

17. A computer-readable medium in accordance with claim 16 wherein the program is further configured to:
calculate an effective pixel value from the initial pixel value by using (Pₑ(i,j)=(P(i,j)+P(i−j)+P(i+1,j)+P(i,j−1)+P(i,j+1))/5, Pₑ(i, j) being the effective pixel value, and P(i−1, j), P(i+1, j), P(i, j−1), and P(i, j+1) being pixel values of pixels that are adjoining the pixel with pixel value P(i, j).

18. A computer-readable medium in accordance with claim 17 wherein the program is further configured to:
calculate the relative pixel value Pᵣ(i,j) from the effective pixel value by using Pᵣ(i, j)=Pₑ(i, j)/T.

19. A computer-readable medium in accordance with claim 18 wherein the program is further configured to calculate the gain factor for the pixel by using
Gain (i, j)=−0.35+0.1*P, (i, j)+0.15*Pᵣ(i, j)²+0.2*Pᵣ(i, j)³+0.4*Pᵣ(i, j)⁴+0.5
wherein Gain(i, j) is the gain factor.

20. A computer configured to:
obtain an image; and
obtain a final pixel value by performing a filtering operation on an initial pixel value of at least one pixel of the image and by modulating the filtering operation with a gain factor that is a function of the initial pixel value.

21. A computed tomographic (CT) imaging system for filtering CT images, the imaging system comprising:
a detector array having a plurality of detectors;
an x-ray source positioned to emit x-rays toward the detector array; and
a processor operationally coupled to the detector array, the processor configured to:
obtain an image; and
obtain a final pixel value by performing a filtering operation on an initial pixel value of at least one pixel of the image and by modulating the filtering operation with a gain factor that is a function of the initial pixel value.

22. A CT system in accordance with claim 21 wherein to obtain the final pixel value the processor configured to obtain the final pixel value by using P_{f}(i,j)=P(i,j)−(P(i,j)−decon(P(i,j)))*Gain(i,j), wherein P(i,j) is the initial pixel value, decon(P(i,j)) is a deconvolution operation performed on the initial pixel value, Gain(i,j) is the gain factor of the pixel, and (i,j) is the pixel.

23. A CT system in accordance with claim 21 wherein the processor is further configured to categorize the image into at least two regions of low, medium, and high density.

24. A CT system in accordance with claim 23 wherein to modulate the filtering operation the processor configured to:
perform a smoothing operation on one of the regions; and
limit the smoothing operation to the region.

25. A CT system in accordance with claim 24 wherein the processor is further configured to determine a threshold value T.
